(19) United States
(12) Patent Application Publication
(10) Pub. No.: US 2025/0202046 A1
(43) Pub. Date: Jun. 19, 2025

(54) SEPARATOR FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Eon Mi LEE, Suwon-si (KR); Chang Hong KO, Suwon-si (KR); Sam Jin PARK, Suwon-si (KR); Soo Hee KIM, Suwon-si (KR); Min Jeong LEE, Suwon-si (KR); Jin Weon SEO, Suwon-si (KR); Yoo Bin HAN, Suwon-si (KR)

(73) Assignee: SAMSUNG SDI CO., LTD., Yongin-si (KR)

(21) Appl. No.: 18/976,053

(22) Filed: Dec. 10, 2024

(30) Foreign Application Priority Data
Dec. 14, 2023 (KR) 10-2023-0182102

(51) Int. Cl. H01M 50/42; H01M 10/052; H01M 50/443

(52) U.S. Cl. CPC H01M 50/42; H01M 10/052; H01M 50/443

(57) ABSTRACT

Examples of the present disclosure relate to a separator for a rechargeable lithium battery, and a rechargeable lithium battery including the separator. The separator for a rechargeable lithium battery includes a porous substrate and a coating layer located on at least one surface of the porous substrate. The coating layer includes a cross-linked product of a binder and a cross-linking agent, a filler and an adhesive binder. The binder includes a (meth)acryl-based binder containing a structural unit derived from (meth)acrylate or (meth)acrylic acid, a cyano group-containing structural unit, and a sulfonate group-containing structural unit. The cross-linking agent includes an aziridine-based cross-linking agent. The filler has a particle diameter D100 of about 1.0 m or less. The adhesive binder includes a cross-linked (meth)acryl-based adhesive binder.

### CROSS-REFERENCE TO RELATED APPLICATION

The present application claims the benefit of priority to Korean Patent Application No. 10-2023-0182102, filed on Dec. 14, 2023 in the Korean Intellectual Property Office, the entire disclosure of which is incorporated herein by reference.

### BACKGROUND

### 1. Field of the Disclosure

Examples of the present disclosure relate to a separator for a rechargeable lithium battery, and a rechargeable lithium battery including the separator.

### 2. Discussion of Related Art

With increasing use of electronic devices, such as, e.g., mobile phones, notebook computers, electric vehicles, and the like, using batteries, the demand for secondary batteries having high energy density and high capacity is increasing.

Therefore, improving the performance of rechargeable lithium batteries may be advantageous.

A rechargeable lithium battery is typically a battery that includes a positive electrode and a negative electrode that include an active material capable of the intercalation and deintercalation of lithium ions, and that produces electric energy by oxidation and reduction reactions when the lithium ions are intercalated into and deintercalated from the positive electrode and the negative electrode.

The rechargeable lithium battery may include a separator between the positive electrode and the negative electrode. The separator is impregnated in an electrolyte solution. It may be desirable to ensure the safety of the battery that the separator does not undergo thermal contraction in the electrolyte solution and maintains an original form thereof.

### SUMMARY OF THE DISCLOSURE

One example embodiment includes a separator for a rechargeable lithium battery, the separator having a low dry shrinkage ratio and a low shrinkage ratio in an electrolyte, thereby increasing the stability of the battery.

Another example embodiment includes a separator for a rechargeable lithium battery, the separator having an increased wet bonding strength and improved high-temperature lifetime characteristics.

Still another example embodiment includes a rechargeable lithium battery including the separator for a rechargeable lithium battery.

According to an example aspect of the present disclosure, a separator for a rechargeable lithium battery includes a porous substrate and a coating layer located on at least one surface of the porous substrate. The coating layer includes a cross-linked product of a binder and a cross-linking agent, a filler, and an adhesive binder. The binder includes a (meth)acryl-based binder containing a structural unit derived from (meth)acrylate or (meth)acrylic acid, a cyano group-containing structural unit, and a sulfonate group-containing structural unit, the cross-linking agent includes an aziridine-based cross-linking agent, the filler has a particle diameter D100 of about 1.0 μm or less, and the adhesive binder includes a cross-linked (meth)acryl-based adhesive binder.

According to another example aspect of the present disclosure, a rechargeable lithium battery includes the separator for a rechargeable lithium battery, a positive electrode, and a negative electrode.

### BRIEF DESCRIPTION OF THE DRAWINGS

FIG. 1 is a cross-sectional view illustrating a separator for a rechargeable lithium battery, according to one example embodiment.

FIGS. 2 to 5 are cross-sectional views schematically illustrating a rechargeable lithium battery, according to one example embodiment.

### DETAILED DESCRIPTION

Hereinafter, example embodiments of the present disclosure are described in detail. However, the example embodiments are presented as examples, and the present disclosure is not limited thereto, and the present disclosure is only defined by the scope of the appended claims.

Unless otherwise stated herein, when a part such as a layer, a membrane, an area, a plate, and the like, is described as being disposed “on” another part, the part is “directly on” another part, and there may be other parts therebetween.

Unless otherwise stated herein, the singular may also include the plural. In addition, unless otherwise stated, the term “A or B” may mean “including A, including B, or including A and B.”

In the present specification, “a combination thereof” may mean a mixture, stack, composite, copolymer, alloy, blend, or reaction product of constituents.

Unless otherwise defined herein, “a particle diameter D100” may refer to a diameter of a particle with a cumulative volume of 100% by volume in a particle diameter distribution. The particle diameter distribution may be measured by methods known to those skilled in the art. For example, the particle diameter distribution may be measured using a particle size analyzer, a transmission electron microscope photograph, or a scanning electron microscope photograph. As another method, the particle diameter distribution may be obtained by measuring the particle diameter using a measuring device using dynamic light scattering, performing data analysis to count the number of particles for each particle size range, and then calculating the particle diameter D100 therefrom. Alternatively, the particle diameter distribution may be measured using a laser diffraction method. When measuring the particle diameter distribution by the laser diffraction method, for example, the particle diameter D100 based on 100% of a particle diameter distribution in the measuring device may be calculated by dispersing particles to be measured in a dispersion medium, then introducing the dispersion medium into a commercially available laser diffraction particle diameter measuring device (e.g., Microtrac's MT 3000), and radiating ultrasonic waves of about 28 kHz with an output of 60 W.

Unless otherwise defined herein, ‘a particle diameter D50’ may refer to a diameter of a particle with a cumulative volume of 50% by volume in a particle diameter distribution. The particle diameter distribution may be obtained from the method descripted in the particle diameter D100.

In the present specification, “(meth)acryl” refers to acryl and/or methacryl.

Hereinafter, unless otherwise defined, “substitution” indicates that hydrogen in a compound is substituted with a substituent such as or including at least one of a C₁ to C₃₀ alkyl group, a C₂ to C₃₀ alkenyl group, a C₂ to C₃₀ alkynyl group, a C₆ to C₃₀ aryl group, a C₇ to C₃₀ alkylaryl group, a C₁ to C₃₀ alkoxy group, a C₁ to C₃₀ heteroalkyl group, a C₃ to C₃₀ heteroalkylaryl group, a C₃ to C₃₀ cycloalkyl group, a C₃ to C₁₅ cycloalkenyl group, a C₆ to C₃₀ cycloalkynyl group, a C₂ to C₃₀ heterocycloalkyl group, a halogen (F, Cl, Br, or I), a hydroxy group (—OH), a nitro group (—NO₂), a cyano group (—CN), an amino group (—NRR′) (Herein, R and R′ are each independently hydrogen or a C₁ to C₆ alkyl group), a sulfobetaine group (—RR′N⁺(CH₂)ₙSO₃⁻, n is a natural number from 1 to 10), a carboxybetaine group (—RR′N⁺(CH₂)ₙCOO⁻, n is a natural number from 1 to 10) (Herein, R and R′ are each independently a C₁ to C₂₀ alkyl group), an azido group (—N₃), an amidino group (—C(=NH)NH₂), a hydrazino group (—NHNH₂), a hydrazono group (=N(NH₂)), a carbamoyl group (—C(O)NH₂), a thiol group (—SH), an acyl group (—C(═O)R, Herein, R denotes hydrogen, a C₁ to C₆ alkyl group, a C₁ to C₆ alkoxy group, or a C₆ to C₁₂ aryl group), a carboxyl group (—COOH) or a salt thereof (—C(═O)OM, Herein, M denotes an organic or inorganic cation), a sulfonic acid group (—SO₃H) or a salt thereof (—SO₃M, Herein, M denotes an organic or inorganic cation), a phosphate group (—PO₃H₂) or a salt thereof (—PO₃MH or —PO₃M₂, Herein, M denotes an organic or inorganic cation), and a combination thereof.

Hereinafter, the C₁ to C₃ alkyl group may be or include at least one of a methyl group, an ethyl group, or a propyl group. The C₁ to C₁₀ alkylene group may be or include, for example, at least one of a C₁ to C₆ alkylene group, a C₁ to C₅ alkylene group, or a C₁ to C₃ alkylene group and may be or include, for example, at least one of a methylene group, an ethylene group, or a propylene group. The C₃ to C₂₀ cycloalkylene group may be or include, for example, at least one of a C₃ to C₁₀ cycloalkylene group, or a C₅ to C₁₀ cycloalkylene group, for example, a cyclohexylene group. The C₆ to C₂₀ arylene group may be or include, for example, a C₆ to C₁₀ arylene group, for example, a phenylene group. The C₃ to C₂₀ heterocyclic group may be or include, for example, a C₃ to C₁₀ heterocyclic group, for example, a pyridine group.

Hereinafter, “hetero” indicates including one or more heteroatoms such as or including at least one of N, O, S, Si, and P.

In addition, in the chemical formulas, the symbol * refers to a part that is connected to the same or different atom, group, or structural unit.

Hereinafter, “alkali metal” refers to an element belonging to Group 1 of the periodic table, such as lithium, sodium, potassium, rubidium, cesium, or francium and may be present in a cationic or neutral state.

In the present specification, when describing a numerical range, “X to Y” indicates “X or more and Y or less (X≤ and ≤KY).”

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

A separator for a rechargeable lithium battery according to one example embodiment includes a porous substrate and a coating layer located on at least one surface of the porous substrate. The coating layer includes a cross-linked product of a binder and a cross-linking agent, a filler, and an adhesive binder. The adhesive binder includes a (meth)acryl-based binder containing a structural unit derived from (meth)acrylate or (meth)acrylic acid, a cyano group-containing structural unit, and a sulfonate group-containing structural unit. The cross-linking agent includes an aziridine-based cross-linking agent. The filler has a particle diameter D100 of about 1.0 m or less, and the adhesive binder includes a cross-linked (meth)acryl-based adhesive binder.

Because the coating layer includes the cross-linked product of the (meth)acryl-based binder and the aziridine-based cross-linking agent, the filler, and the adhesive binder, the separator for a rechargeable lithium battery may have a significantly low dry shrinkage ratio and shrinkage ratio in an electrolyte. The dry shrinkage ratio is measured after the separator is left at a high temperature, and the shrinkage ratio in the electrolyte is measured after the separator is left at a high temperature in a state of being impregnated with the electrolyte.

According to one example embodiment, the dry shrinkage ratio of the separator for a rechargeable lithium battery may be about 5% or less, and the shrinkage ratio in the electrolyte may be about 15% or less, for example, 10% or less, or for example, 5% or less.

According to one example embodiment, the separator for a rechargeable lithium battery exhibits a significantly low shrinkage ratio in the electrolyte. The shrinkage ratio in the electrolyte is obtained in consideration of an application location of the separator in the rechargeable lithium battery. The separator may be saturated with the electrolyte. A separator with a low shrinkage ratio in an electrolyte can increase the stability of the battery by maintaining heat resistance properties without weakening the mechanical properties of the (meth)acryl-based binder when the separator is saturated with the electrolyte.

A separator formed of or including a composition containing the (meth)acryl-based binder, but that does not include the aziridine-based cross-linking agent as a cross-linking agent, or that includes a crosslinking agent other than the aziridine-based cross-linking agent, may not satisfy the above shrinkage ratio range in the electrolyte.

According to one example embodiment, the aziridine-based cross-linking agent may be contained in an amount of about 95 wt % or more, for example, in the range of 98 to 100 wt %, or for example, 100 wt % of the total cross-linking agent in the composition.

A separator formed of or including a composition containing the (meth)acryl-based binder, but that does not include a filler having a particle diameter D100 of about 1.0 μm or less, or that includes a filler having a particle diameter D100 of more than about 1.0 μm, may not satisfy the above shrinkage ratio range in the electrolyte. A separator formed of or including a composition containing the aziridine-based cross-linking agent and the filler, but that does not include the (meth)acryl-based binder, or that includes a binder other than the (meth)acryl-based binder, may not satisfy the above dry shrinkage ratio and shrinkage ratio ranges in electrolyte. According to one example embodiment, the (meth)acryl-based binder may be contained in an amount of about 95 wt % or more, for example, in the range of 98 to 100 wt %, or for example, 100 wt % of the total binder in the composition.

According to one example embodiment, the coating layer may be formed from or including the composition containing the (meth)acryl-based binder, the aziridine-based cross-linking agent, and the filler having a particle diameter D100 of about 1.0 m or less, and the adhesive binder.

According to one example embodiment, the coating layer may include a heat-resistant layer containing a cross-linked product of the (meth)acryl-based binder, the aziridine-based cross-linking agent, and the filler having a particle diameter D100 of about 1.0 μm or less, and an adhesive layer located on the heat-resistant layer and containing the adhesive binder. According to one example embodiment, the cross-linked product may be or include a heat cross-linked product. According to one example embodiment, the heat-resistant layer may be formed from or including the composition.

### Coating Layer

The coating layer includes the heat-resistant layer and the adhesive layer formed on the heat-resistant layer.

The binder includes a (meth)acryl-based binder containing a structural unit derived from (meth)acrylate or (meth)acrylic acid, a cyano group-containing structural unit, and a sulfonate group-containing structural unit.

The (meth)acryl-based binder is or includes a water-based heat-resistant binder, and may fix the filler to a porous substrate, provide bonding strength so that the coating layer is bonded to the porous substrate and an electrode, and contribute to increasing the heat resistance, air permeability, and oxidation resistance of the separator.

In the structural unit derived from the (meth)acrylate or the (meth)acrylic acid, the (meth)acrylate may be or include a conjugate base of (meth)acrylic acid, a (meth)acrylic acid salt, or a derivative thereof. The structural unit derived from the (meth)acrylate or the (meth)acrylic acid may be represented, for example, by Chemical Formula 1, 2, 3 below, or a combination thereof:

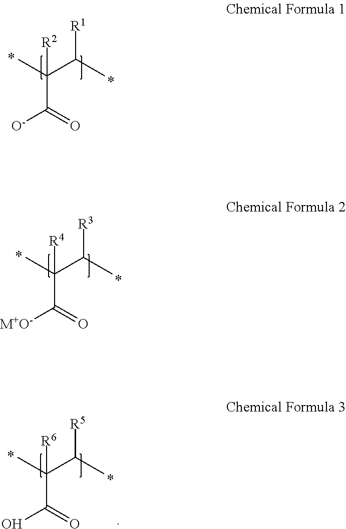

In Chemical Formulas 1 to 3,
R¹, R², R³, R⁴, R⁵, and R⁶ each is or includes independently hydrogen or a methyl group, and
in Chemical Formula 2,
M is or includes an alkali metal.

The alkali metal may be or include, for example, at least one of lithium, sodium, potassium, rubidium, or cesium.

The structural unit derived from the (meth)acrylate or the (meth)acrylic acid may be included in the (meth)acryl-based binder in an amount ranging from about 10 mol % to about 70 mol %, for example, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70 mol %, for example, from 20 mol % to 60 mol %, for example, from 30 mol % to 60 mol %, for example, from 40 mol % to 55 mol %, or for example, from 10 mol % to 50 mol %. When the structural unit derived from the (meth)acrylate or the (meth)acrylic acid is included within the above ranges, a separator containing the (meth)acryl-based binder can exhibit a desired or improved bonding strength, heat resistance, air permeability, and oxidation resistance.

For example, the structural unit derived from the (meth)acrylate or the (meth)acrylic acid may include the structural unit represented by Chemical Formula 2 and the structural unit represented by Chemical Formula 3, and in this case, a molar ratio of the structural unit represented by Chemical Formula 2 and the structural unit represented by Chemical Formula 3 may range from 10:1 to 1:2, from 10:1 to 1:1, or from 5:1 to 1:1.

The cyano group-containing structural unit may be, for example, represented by Chemical Formula 4 below:

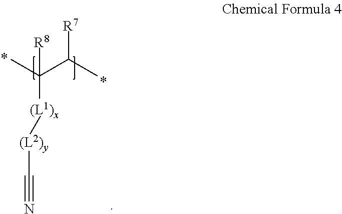

In Chemical Formula 4,
R⁷ and R⁸ each independently is or includes hydrogen or a C₁ to C₃ alkyl group,
L¹ is or includes —C(═O)—, —C(═O)O—, —OC(═O)—, —O—, or —C(═O)NH—,
x is an integer ranging from 0 to 2,
L² is or includes a substituted or unsubstituted C₁ to C₁₀ alkylene group, a substituted or unsubstituted C₃ to C₂₀ cycloalkylene group, a substituted or unsubstituted C₆ to C₂₀ arylene group, or a substituted or unsubstituted C₃ to C₂₀ heterocyclic group, and
y is an integer ranging from 0 to 2.

The cyano group-containing structural unit may be or include, for example, at least one of a structural unit derived from (meth)acrylonitrile, an alkene nitrile, cyanoalkyl (meth)acrylate, or 2-(vinyloxy)alkanenitrile. Herein, the alkene may be or include at least one of a C₁ to C₂₀ alkene, a C₁ to C₁₀ alkene, or a C₁ to C₆ alkene, the alkyl may be or include at least one of a C₁ to C₂₀ alkyl, a C₁ to C₁₀ alkyl, or a C₁ to C₆ alkyl, and the alkane may be or include at least one of a C₁ to C₂₀ alkane, a C₁ to C₁₀ alkane, or a C₁ to C₆ alkane.

The alkene nitrile may be or include, for example, at least one of allyl cyanide, 4-pentenenitrile, 3-pentenenitrile, 2-pentenenitrile, 5-hexenenitrile, etc. The cyanoalkyl (meth)acrylate may be or include, for example, at least one of cyanomethyl (meth)acrylate, cyanoethyl (meth)acrylate, cyanopropyl (meth)acrylate, cyanooctyl (meth)acrylate, etc. The 2-(vinyloxy)alkanenitrile may be or include, for example, at least one of 2-(vinyloxy)ethanenitrile, 2-(vinyloxy)propanenitrile, and the like.

The cyano group-containing structural unit may be included in the (meth)acryl-based binder in an amount ranging from about 30 mol % to about 85 mol %, for example, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85 mol %, for example, from 40 mol % to 85 mol %, from 30 mol % to 70 mol %, from 30 mol % to 60 mol %, or from 35 mol % to 55 mol %. When the cyano group-containing structural unit is included within the above ranges, the (meth)acryl-based binder and the separator including the (meth)acryl-based binder can exhibit a desired or improved oxidation resistance and exhibit a desired or improved bonding strength, heat resistance, and air permeability.

The sulfonate group-containing structural unit may be or include a structural unit containing at least one of a conjugate base of sulfonic acid, a sulfonate salt, sulfonic acid, or a derivative thereof. For example, the sulfonate group-containing structural unit may be represented by Chemical Formula 5, 6, 7 below, or a combination thereof:

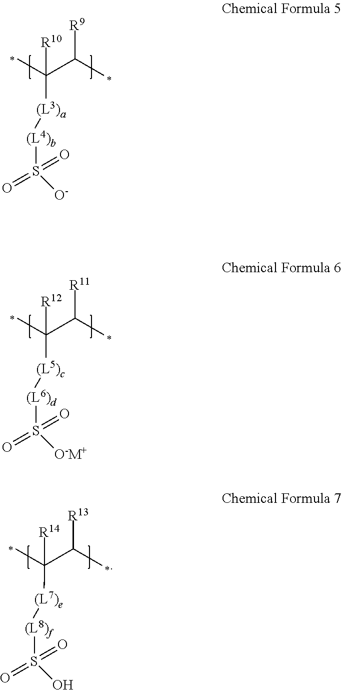

In Chemical Formulas 5 to 7,
R⁹, R¹⁰, R^{D}, R¹², R¹³, and R¹⁴ each is or includes independently hydrogen or a C₁ to C₃ alkyl group,
L³, L⁵, and L⁷ each independently is or includes —C(═O)—, —C(═O)O—, —OC(═O)—, —O—, or —C(═O)NH—,
L⁴, L⁶, and L⁸ each independently is or includes a substituted or unsubstituted C₁ to C₁₀ alkylene group, a substituted or unsubstituted C₃ to C₂₀ cycloalkylene group, a substituted or unsubstituted C₆ to C₂₀ arylene group, or a substituted or unsubstituted C₃ to C₂₀ heterocyclic group, and
a, b, c, d, e, and f are each independently an integer ranging from 0 to 2, and in Chemical Formula 6,
M is or includes an alkali metal.

For example, in Chemical Formulas 5 to 7,
L³, L⁵, and L⁷ each independently is or includes —C(═O)NH—,
L⁴, L⁶, and L⁸ each independently is or includes a C1 to C10 alkylene group, and
a, b, c, d, e, and f may each be an integer equal to 1.

The sulfonate group-containing structural unit may include only one or two or more of the structural unit represented by Chemical Formula 5, the structural unit represented by Chemical Formula 6, and the structural unit represented by Chemical Formula 7. As an example, the sulfonate group-containing structural unit may include the structural unit represented by Chemical Formula 6, and as another example, the sulfonate group-containing structural unit may include the structural unit represented by Chemical Formula 6 and the structural unit represented by Chemical Formula 7.

The sulfonate group-containing structural unit may be or include, for example, a structural unit derived from at least one of vinyl sulfonic acid, allyl sulfonic acid, styrene sulfonic acid, anethole sulfonic acid, (meth)acrylamidoalkane sulfonic acid, sulfoalkyl (meth)acrylate, or salts thereof.

Herein, the alkane may be or include at least one of a C₁ to C₂₀ alkane, a C₁ to C₁₀ alkane, or a C₁ to C₆ alkane, and the alkyl may be or include at least one of a C₁ to C₂₀ alkyl, a C₁ to C₁₀ alkyl, or a C₁ to C₆ alkyl. The salt refers to a salt composed of the above-described sulfonic acid and a desired ion. The ion may be or include, for example, an alkali metal ion, and in this case, the salt may be an alkali metal salt of sulfonic acid.

The (meth)acrylamidoalkane sulfonic acid may be or include, for example, at least one of 2-(meth)acrylamido-2-methylpropanesulfonic acid, and the sulfoalkyl (meth)acrylate may be or include, for example, at least one of 2-sulfoethyl(meth)acrylate, 3-sulfopropyl (meth)acrylate, and the like.

The sulfonate group-containing structural unit may be included in the (meth)acryl-based binder in an amount ranging from about 0.1 mol % to about 20 mol %, for example 0.1, 0.5, 1, 2, 3, 4, 5, 6, 7, 8, 9, 10, 11, 12, 13, 14, 15, 16, 17, 18, 19, 20 mol %, for example, from 0.1 mol % to 10 mol %, for example, from 1 mol % to 20 mol %, or for example, from 1 mol % to 10 mol %. When the sulfonate group-containing structural unit is included within the above ranges, the (meth)acryl-based binder and the separator including the (meth)acryl-based binder can exhibit desired or improved bonding strength, heat resistance, air permeability, and oxidation resistance.

As described above, the (meth)acryl-based binder may include an alkali metal. The alkali metal may be present in the form of a cation and for example, may be or include at least one of lithium, sodium, potassium, rubidium, or cesium. For example, the alkali metal may be combined with the (meth)acryl-based binder and may be present in the form of a salt. The alkali metal may assist in the synthesis of the (meth)acryl-based binder in an aqueous solvent, increase the bonding strength of the coating layer, and increase the heat resistance, air permeability, oxidation resistance, and the like, of the separator.

The alkali metal may be included in an amount ranging from about 1 wt % to about 40 wt % of the alkali metal and the (meth)acryl-based binder, for example, from 1 wt % to 30 wt %, from 1 wt % to 20 wt %, or from 10 wt % to 20 wt %. For example, the (meth)acryl-based binder and the alkali metal may be included in a weight ratio of about 99:1 to about 60:40, a weight ratio of 99:1 to 70:30, for example, a weight ratio of 99:1 to 80:20, or for example, a weight ratio of 90:10 to 80:20.

In addition, the alkali metal may be included in an amount ranging from about 0.1 mol % to about 1.0 mol % with respect to the total content of the alkali metal and the (meth)acryl-based binder. When the alkali metal is included within the above range, the coating layer can have a desired or improved bonding strength, and a separator including the coating layer may exhibit a desired or improved heat resistance, air permeability, and oxidation resistance.

The (meth)acryl-based binder may be, for example, represented by Chemical Formula 8 below:

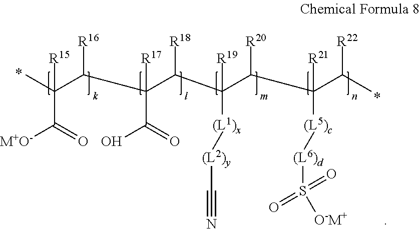

In Chemical Formula 8,
R¹⁵, R¹⁶, R¹⁷, and R¹⁸ each independently is or includes hydrogen or a methyl group,
R¹⁹, R²⁰, R²¹, and R²² each independently is or includes hydrogen or a C₁ to C₃ alkyl group,
L¹ and L⁵ each independently is or includes —C(═O)—, —C(═O)O—, —OC(═O)—, —O—, or —C(═O)NH—,
L² and L⁶ each independently is or includes a substituted or unsubstituted C₁ to C₁₀ alkylene group, a substituted or unsubstituted C₃ to C₂₀ cycloalkylene group, a substituted or unsubstituted C₆ to C₂₀ arylene group, or a substituted or unsubstituted C₃ to C₂₀ heterocyclic group,
x, y, c, and d are each independently an integer ranging from 0 to 2,
M is or includes an alkali metal such as or including at least one of lithium, sodium, potassium, rubidium, or cesium, and
k, l, m, and n refer to a molar ratio of each structural unit.

As an example, in Chemical Formula 11, k+l+m+n=1. In addition, as an example, 0.1≤(k+l)≤0.5, 0.4≤m≤0.85, and 0.001≤n≤0.2, for example, 0.1≤k≤0.5 and 0≤1≤0.25.

For example, in Chemical Formula 11, x=y=0, L⁵ is or includes —C(═O)NH—, L⁶ is or includes a C1 to C10 alkylene group, and c=d=1.

A degree of substitution of the alkali metal (M+) in the (meth)acryl-based binder may range from about 0.5 to about 1.0, for example, from 0.6 to 0.9 or from 0.7 to 0.9 with respect to (k+n). When the degree of substitution of the alkali metal satisfies the above ranges, the (meth)acryl-based binder and the separator including the (meth)acryl-based binder can exhibit a desired or improved bonding strength, heat resistance, and oxidation resistance.

The (meth)acryl-based binder may be in various forms, such as an alternating polymer in which the units are alternately distributed, a random polymer in which the units are randomly distributed, or a graft polymer in which some structural units are grafted.

A weight average molecular weight (Mw) of the (meth)acryl-based binder may range from about 200,000 g/mol to about 700,000 g/mol, for example, 200,000 g/mol to 600,000 g/mol, or for example, 300,000 g/mol to 600,000 g/mol. When the weight average molecular weight of the (meth)acryl-based binder satisfies the above ranges, the (meth)acryl-based binder and the separator including the (meth)acryl-based binder can exhibit a desired or improved bonding strength, heat resistance, air permeability, and oxidation resistance. The weight average molecular weight may be or include a polystyrene-converted average molecular weight measured using gel permeation chromatography.

A glass transition temperature of the (meth)acryl-based binder may range from about 200° C. to about 280° C., for example, from 210° C. to 270° C., or for example, from 210° C. to 260° C. When the glass transition temperature of the (meth)acryl-based binder satisfies the above ranges, the (meth)acryl-based binder and the separator including the (meth)acryl-based binder can exhibit a desired or improved bonding strength, heat resistance, air permeability, and oxidation resistance. The glass transition temperature may be a value measured by differential scanning calorimetry.

The (meth)acryl-based binder may be prepared by, e.g., a solution polymerization method.

According to one example embodiment, the (meth)acryl-based binder may be contained in the coating layer of the separator in the form of a film.

The cross-linking agent includes an aziridine-based cross-linking agent. The aziridine-based cross-linking agent may crosslink the (meth)acryl-based binder, and allow the separator to readily satisfy the above dry shrinkage ratio and shrinkage ratio ranges in the electrolyte.

The aziridine-based cross-linking agent may be or include a bi-functional or higher aziridine-based cross-linking agent. Herein, “bi-functional or higher” indicates that two or more aziridine groups are present in a molecule. According to one example embodiment, the aziridine-based cross-linking agent may be or include a bi- or tri-functional aziridine-based cross-linking agent.

For example, the aziridine-based cross-linking agent may include one or more of N,N′-toluene-2,4-bis(1-aziridinecarboxamide), N,N′-(methylenedi-p-phenylene)bis(aziridine-1-carboxamide), triethylenemelamine, 1,1-isophthaloyl bis(2-methylaziridine), tris(1-aziridinyl)phosphine oxide, N,N-hexamethylene-bis(aziridine carboxamide), trimethylolpropane tris(2-methyl-1-aziridine propionate), trimethylolpropane tris(beta-N-aziridinyl)propionate, and pentaerythritol tris(3-(1-aziridinyl)propionate).

The cross-linking agent, for example, the aziridine-based cross-linking agent, may be included in a desired amount with respect to the binder, for example, the (meth)acryl-based binder. According to one example embodiment, the aziridine-based cross-linking agent may be contained in an amount ranging from about 5 wt % to about 50 wt %, for example 5, 10, 15, 20, 25, 30, 35, 40, 45, 50 wt %, for example, from 10 to 40 wt %, or for example, from 10 to 20 wt % with respect to the content of the (meth)acryl-based binder. Within the above ranges, it is possible to reduce the shrinkage in the electrolyte.

The filler has a particle diameter D100 of about 1.0 μm or less. Within the above range, the separator may readily satisfy the dry shrinkage ratio and the shrinkage ratio in the electrolyte when the (meth)acryl-based binder is combined with the aziridine-based cross-linking agent. For example, the filler may have a particle diameter D100 of 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, about 1.0 μm, about 0.5 μm to about 0.7 μm.

According to one example embodiment, the filler may have a particle diameter D50 of about 0.4 μm or less, for example, 0.05, 0.1, 0.15, 0.2, 0.25, 0.3, 0.35, 0.4 μm, for example, 0.35 μm or less. Within the above ranges, it is possible to reduce the shrinkage in the electrolyte.

The filler may be or include, for example, an inorganic filler, an organic filler, an organic-inorganic composite filler, or combinations thereof. The inorganic filler may be or include a ceramic material that can increase heat resistance. The inorganic filler may include, for example, at least one of a metal oxide, a metalloid oxide, a metal fluoride, a metal hydroxide, or combinations thereof. The inorganic filler may include, for example, at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or combinations thereof, but is not limited thereto. The organic filler may include at least one of an acrylic compound, an imide compound, an amide compound, or combinations thereof, but is not limited thereto. The organic filler may have a core-shell structure, but is not limited thereto.

The filler may be substantially spherical, substantially plate-shaped, substantially cubic, or amorphous. For example, the filler may be plate-shaped.

The filler may be included in a desired amount with respect to the binder, for example, the (meth)acryl-based binder. According to one example embodiment, a mass ratio of the (meth)acryl-based binder and the filler may range from about 1:10 to about 1:50, for example, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, from 1:10 to 1:40, or from 1:20 to 1:30. Within the above ranges, the dry shrinkage ratio and the shrinkage ratio in the electrolyte can be reduced.

The filler may be contained in an amount ranging from about 50 wt % to about 99 wt %, for example, from 70 wt % to 99 wt %, for example, from 75 wt % to 99 wt %, for example, from 80 wt % to 99 wt %, for example, from 85 wt % to 99 wt %, for example, from 90 wt % to 99 wt %, or for example, from 95 wt % to 99 wt % of the total amount of the coating layer. When the filler is included within the above ranges, the separator can exhibit a desired or improved heat resistance, durability, oxidation resistance, and stability.

The adhesive binder may be configured to secure the bonding strength with the electrode of the separator. Because the heat resistance and bonding strength are physical properties that have a trade-off relationship, in one example embodiment, the coating layer may further include the adhesive binder together with the (meth)acryl-based binder so that the (meth)acryl-based binder and the adhesive binder are each independently present in the coating layer, thereby resulting in a separator with desired or improved heat resistance and bonding strength.

In addition, by the adhesive binder, the separator can maintain the heat resistance and the bonding strength, increase the stability and lifetime of a battery, and also increase the resistance of the battery when the separator is later included in the battery.

The adhesive binder may be crosslinked. According to one example embodiment, the adhesive binder is or includes a (meth)acryl-based adhesive binder, and may be or include at least one of a cross-linked (meth)acrylate-based polymer or copolymer. For example, the adhesive binder may include a cross-linked polymethyl (meth)acrylate-based polymer.

To prepare the cross-linked (meth)acryl-based polymer, a cross-linking agent may be further added during a polymerization operation.

When the (meth)acryl-based adhesive binder has a glass transition temperature, the glass transition temperature may range from about 50° C. or higher to about 110° C. or lower. Within the above range, not only the bonding strength of the electrode is desired or improved, but also ionic conductivity is improved.

The adhesive binder may have a predetermined swelling degree with respect to an electrolyte. For example, a mass increase rate (swelling degree) due to the electrolyte when the adhesive binder is left at 60° C. for 72 hours may range from 50% to 500% or less. Within the above electrolyte swelling degree range, a bonding area of the coating layer in the electrolyte can be increased, and there can be no challenge of reduced bonding strength due to swelling and increased battery resistance due to an Li ion movement path being blocked. Herein, as an electrolyte included to measure the electrolyte swelling degree, LiPF₆ dissolved in a mixed solvent of ethylene carbonate (EC), diethyl carbonate (DEC), and dimethyl carbonate (DMC) (volume mixing ratio: EC/DEC/DMC=2/4/4, 1 mol/L of a concentration of LiPF₆ as a supporting electrolyte) may be used.

In addition, the electrolyte swelling degree may be measured as follows.

First, a polymer is prepared. Then, a film is manufactured using the prepared polymer. For example, when the polymer is a solid, a film with a thickness of 0.5 mm is manufactured by drying the polymer at a temperature of 85° C. for 48 hours, and molding the polymer into a film. For example, when the polymer is a solution or a dispersion, such as latex, a film with a thickness of 0.5 mm is manufactured by placing the solution or the dispersion in a polytetrafluoroethylene dish and drying the solution or dispersion at a temperature of 85° C. for 48 hours.

Next, a test sample is obtained by cutting the film manufactured as above into 1 cm squares. A weight of the test sample is measured and set as W₀. In addition, the test sample is immersed in the electrolyte at a temperature of 60° C. for 72 hours, and the test sample is taken out of the electrolyte. The electrolyte on the surface of the test sample, which has been taken out of the electrolyte, is wiped off, and a weight W₁ of the test sample after immersion is measured.

In addition, using the weights W₀ and W₁, the swelling degree S (times) is calculated as S=W₁/W₀.

In addition, a method of adjusting the electrolyte swelling degree of the polymer may include, for example, appropriately selecting the type and amount of monomers for preparing the polymer in consideration of a solubility parameter (SP) value of the electrolyte.

The adhesive binder may be contained in an amount ranging from about 1% to about 20 wt %, for example, 1, 2, 3, 4, 5, 6, 7, 8, 9, 10, 11, 12, 13, 14, 15, 16, 17, 18, 19, 20 wt %, 5 to 20 wt %, for example, 5 to 15 wt % with respect to the total amount of the coating layer. Within the above ranges, the bonding strength to the electrode can be exhibited, and battery resistance does not increase, and thus there may be no limit to capacity implementation.

The coating layer may have a thickness ranging from about 0.01 μm to about m, and within the above range, may have a thickness ranging from about 1 μm to m, from about 1 μm to 5 μm, or from about 1 μm to 3 m.

A ratio of the thickness of the coating layer to the thickness of the porous substrate may range from about 0.05 to about 0.5, for example, from 0.05 to 0.4, from 0.05 to 0.3, or from 0.1 to 0.2. Within the above ranges, the separator can exhibit a desired or improved air permeability, heat resistance, bonding strength, and the like. Herein, the “thickness of the coating layer” indicates a thickness of one coating layer when the coating layer is formed on only one surface of the porous substrate, and a thickness of two coating layers when the coating layer is formed on both surfaces of the porous substrate.

### Porous Substrate

The porous substrate may be or include a substrate having multiple pores and is commonly present in electrochemical devices. The porous substrate may be or include a polymer membrane formed of or including any one polymer such as or including at least one of a polyolefin such as polyethylene or polypropylene, polyester such as polyethylene terephthalate or polybutylene terephthalate, polyacetal, polyamide, polyimide, polycarbonate, polyether ether ketone, polyaryl ether ketone, polyetherimide, a polyamideimide, polybenzimidazole, polyethersulfone, polyphenylene oxide, cyclic olefin copolymer, polyphenylene sulfide, polyethylene naphthalate, glass fiber, Teflon, and polytetrafluoroethylene, or a copolymer or mixture of two or more types thereof.

The porous substrate may be or include, for example, a polyolefin-based substrate containing a polyolefin, and the polyolefin-based substrate may have an desired or improved shutdown function, thereby contributing to increasing the safety of the battery. The polyolefin-based substrate may be or include, for example, at least one of a polyethylene single film, a polypropylene single film, a polyethylene/polypropylene double film, a polypropylene/polyethylene/polypropylene triple film, and a polyethylene/polypropylene/polyethylene triple film. In addition, the polyolefin-based resin may include a non-olefin resin in addition to an olefin resin or include a copolymer of olefin and non-olefin monomers.

The porous substrate may have a thickness ranging from about 1 μm to about m, for example, from 1 μm to 30 μm, from 1 μm to 20 μm, or from 5 μm to 15 μm.

The separator for a rechargeable lithium battery according to one example embodiment may have desired or improved wet bonding strength. For example, the separator for a rechargeable lithium battery may have a bonding strength of about 0.1 gf/mm or more, for example, ranging from 0.1 gf/mm to 0.3 gf/mm.

The separator for a rechargeable lithium battery according to one example embodiment may exhibit desired or improved air permeability and have an air permeability value of, for example, less than about 200 sec/100 cc, for example, 190 sec/100 cc or less, or 180 sec/100 cc or less. That is, the separator may have an air permeability value of less than about 40 sec/100 cc·1 μm per unit thickness, for example, 30 sec/100 cc·1 μm or less, or 25 sec/100 cc·1 μm or less. Herein, the air permeability refers to the time (seconds) it takes for 100 cc of air to pass through the unit thickness of the separator. The air permeability per unit thickness may be obtained by measuring the air permeability for the total thickness of the separator, and dividing the air permeability by the thickness. The air permeability may be obtained by measuring the time it takes for 100 cc of air to pass through the separator using air permeability measuring equipment (EG01-55-1MR, Asahi Seiko Co., Ltd.).

The separator for a rechargeable lithium battery according to one example embodiment may be formed by applying a composition for forming a coating layer on one surface or both surfaces of a porous substrate, drying, and then curing the coating layer. The curing may be performed using conventional methods known to those skilled in the art.

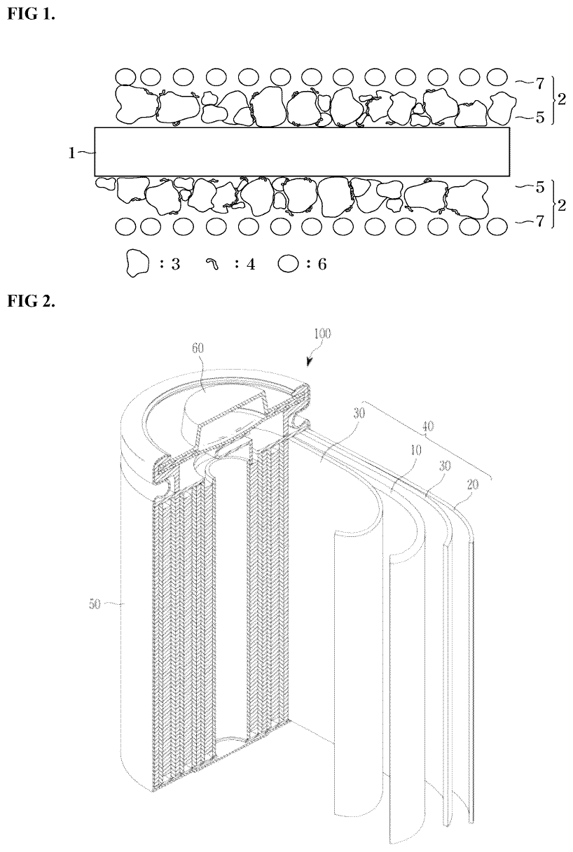

FIG. 1 is a cross-sectional view illustrating a separator for a rechargeable lithium battery according to one example embodiment.

Referring to FIG. 1, the separator for a rechargeable lithium battery includes a porous substrate 1 and a coating layer 2 located on both surfaces of the porous substrate 1. The coating layer 2 may include a heat-resistant layer 5 containing a filler 3 and a cross-linked product 4 of a (meth)acryl-based binder and a cross-linking agent, and an adhesive layer 7 located on the heat-resistant layer 5 and containing an adhesive binder 6.

According to one example embodiment, a thickness of the heat-resistant layer may range from about 0.8 to about 2.5 μm, for example, from 0.9 to 2.2 μm, or from 1.0 to 2.0 μm. A thickness of the adhesive layer may range from 0.5 to 2.0 μm, for example, 0.5 to 1.5 μm.

### Rechargeable Lithium Battery

According to one example embodiment, the rechargeable lithium battery includes the separator for a rechargeable lithium battery, a positive electrode, and a negative electrode.

The separator for rechargeable lithium battery refers to the description described above. The separator for rechargeable lithium battery may be located between the positive electrode and the negative electrode.

### Positive Electrode

A positive electrode for a rechargeable lithium battery may include a current collector and a positive electrode active material layer on the current collector. The positive electrode active material layer may include a positive electrode active material, and may further include a binder and/or a conductive material. For example, the positive electrode may further include an additive that can form a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof, may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O₂₋ₐDₐ (0.90≤a≤1.8, 0≤b≤0.5, 0≤c≤0.5, and 0≤α≤2); LiₐN_{1-b-c}Mn_{b}X_{c}O_{2-α}D_{α} (0.90≤a≤1.8, 0≤b≤0.5, 0≤c≤0.5, and 0≤a≤2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐM_{1-g}G_{g}PO₄ (0.90≤a≤1.8 and 0≤g≤0.5); Li(_{3-f})Fe₂(PO₄)₃ (0≤f≤2); or LiₐFePO₄ (0.90≤a≤1.8).

In the above Chemical Formulas, A is or includes at least one of Ni, Co, Mn, or a combination thereof, X is or includes at least one of Al, Ni, Co, Mn, Cr, Fe, Mg, Sr, V, a rare earth element or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

The positive electrode active material may be or include, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of exhibiting high capacity, and can be applied to a high-capacity, high-density rechargeable lithium battery.

An amount of the positive electrode active material may be in a range of about 90 wt % to about 99.5 wt % based on 100 wt % of the positive electrode active material layer. Amounts of the binder and the conductive material may be in a range of about 0.5 wt % to about 5 wt %, respectively, based on 100 wt % of the positive electrode active material layer.

The binder is configured to attach the positive electrode active material particles to each other, and also to attach the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be configured to impart conductivity (e.g., electrical conductivity) to the electrode. Any material that does not cause chemical change (e.g., does not cause an undesirable chemical change in the rechargeable lithium battery), and that conducts electrons, can be included in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, etc., in a form of a metal powder or a metal fiber; a conductive polymer such as a polyphenylene derivative; or a mixture thereof.

Al may be included as the current collector, but is not limited thereto.

### Negative Electrode

The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be or include graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include at least one of a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include at least one of a composite of silicon and amorphous carbon. According to an example embodiment, the silicon-carbon composite may be in the form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core.

The Si-based negative electrode active material, or the Sn-based negative electrode active material, may be combined with a carbon-based negative electrode active material.

The binder may be configured to attach the negative electrode active material particles to each other, and also to attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is included as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may be configured to impart conductivity (e.g., electrical conductivity) to the electrode. Any material that does not cause chemical change (e.g., that does not cause an undesirable chemical change in the rechargeable lithium battery), and that conducts electrons, can be included in the battery. Non-limiting examples thereof may include a carbon-based material such as or including at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in a form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may form a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like and the aprotic solvent may include at least one of nitriles such as R-CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be included alone or in combination of two or more solvents.

In addition, when using a carbonate-based solvent, a cyclic carbonate and a chain carbonate may be mixed and used, and the cyclic carbonate and the chain carbonate may be mixed in a volume ratio in a range of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The rechargeable lithium battery may be classified into cylindrical, prismatic, pouch, or coin-type batteries, and the like depending on their shape.

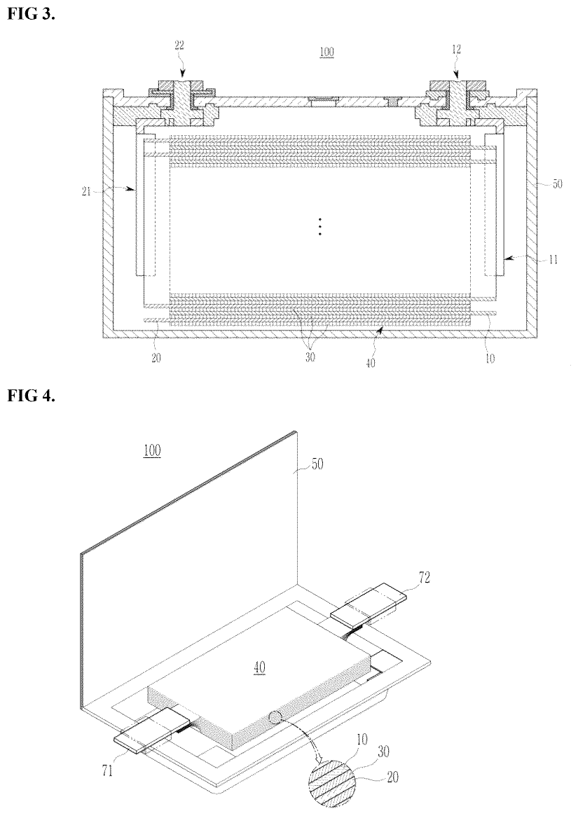

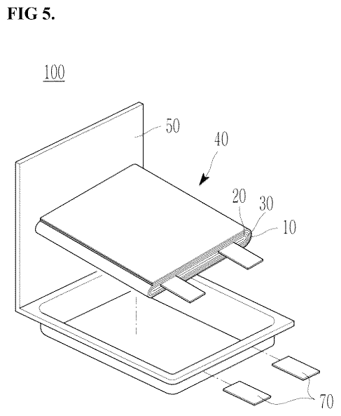

FIGS. 2-5 are schematic views illustrating a rechargeable lithium battery, according to an example embodiment. FIG. 2 illustrates a cylindrical battery, FIG. 3 illustrates a prismatic battery, and FIGS. 4 and 5 illustrate pouch-type batteries. Referring to FIGS. 2-5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as illustrated in FIG. 2. In FIG. 3, the rechargeable lithium battery 100 may include a positive lead tab 11, a positive terminal 12, a negative lead tab 21, and a negative terminal 22. As illustrated in FIGS. 4 and 5, the rechargeable lithium battery 100 may include an electrode tab 70 illustrated in FIG. 5, which may be, for example, a positive electrode tab 71 and a negative electrode tab 72 illustrated in FIG. 4, the electrode tabs 70/71/72 forming an electrical path for inducing the current formed in the electrode assembly 40 to the outside of the battery 100.

The rechargeable lithium battery according to an example embodiment may be applicable to automobiles, mobile phones, and/or various types of electric devices, as non-limiting examples.

The following Examples and Comparative Examples are provided in order to highlight characteristics of one or more example embodiments, but it is understood that the Examples and Comparative Examples are not to be construed as limiting the scope of the example embodiments, nor are the Comparative Examples to be construed as being outside the scope of the example embodiments. Further, it is understood that the example embodiments are not limited to the particular details described in the Examples and Comparative Examples.

### Preparation Example 1

In a 3 L four-necked flask provided with a stirrer, a thermometer, and a cooling tube, a process of adding distilled water (968 g), acrylic acid (AA) (54.00 g, 0.62 mol), ammonium persulfate (0.65 g, 2.85 mol), 2-acrylamido-2-methylpropanesulfonic acid (AMPS) (6.00 g, 0.02 mol), and a 20% aqueous sodium hydroxide solution (0.8 equivalents with respect to the total amount of acrylic acid and 2-acrylamido-2-methylpropanesulfonic acid), then reducing an internal pressure to 10 mmHg using a diaphragm pump, and returning the internal pressure to a normal pressure using nitrogen was repeated three times, and then acrylonitrile (AN) (60.00 g, 0.94 mol) was added.

The reaction was carried out for 18 hours while controlling the temperature of a reaction solution to be stable between 65° C. and 70° C., and after adding ammonium persulfate (0.22 g, 0.95 mol) for the second time, the temperature was raised to 80° C., and the reaction was carried out for another 4 hours. After cooling to room temperature, the pH of the reaction solution was adjusted to 7 to 8 using a 25% aqueous ammonia solution.

Accordingly, poly(acrylic acid-co-acrylic acid lithium salt-co-acrylonitrile-co-2-acrylamido-2-methylpropane sulfonic acid lithium salt) was prepared. A molar ratio of acrylic acid+lithium acrylic acid salt, acrylonitrile and 2-acrylamido-2-methylpropane sulfonic acid lithium salt was 39:59:2. A non-volatile component in about 10 mL of the reaction solution (reaction product) was measured and the measurement result was 9.0 wt % (theoretical value: 10%).

### Preparation Example 2

An acryl-based binder was prepared in the same manner as Preparation Example 1, with a difference that acrylic acid and acrylonitrile were used and 2-acrylamido-2-methylpropane sulfonic acid were not used. A molar ratio of acrylic acid+lithium acrylic acid salt and acrylonitrile was 42:58. The non-volatile component of the reaction solution was 9.0 wt % (theoretical value: 10%).

### Preparation Example 3

An acryl-based binder was prepared in the same manner as Preparation Example 1, with a difference that acrylic acid and 2-acrylamido-2-methylpropane sulfonic acid were used and acrylonitrile was not used. A molar ratio of acrylic acid+lithium acrylic acid salt and 2-acrylamido-2-methylpropane sulfonic acid was 74:26. The non-volatile component of the reaction solution was 9.0 wt % (theoretical value: 10%).

### Preparation Example 4

An acryl-based binder was prepared in the same manner as Preparation Example 1, with a difference that acrylonitrile and 2-acrylamido-2-methylpropane sulfonic acid were used and acrylic acid was not used. A molar ratio of acrylonitrile and 2-acrylamido-2-methylpropane sulfonic acid was 74:26. The non-volatile component of the reaction solution was 9.0 wt % (theoretical value: 10%).

Table 1 below illustrates the molar ratio, weight average molecular weight, and glass transition temperature of each monomer among the (meth)acryl-based binders prepared in Preparation Examples 1 to 4.

TABLE 1

| | | | | Weight average | Glass |
|---|---|---|---|---|---|
| | | | | molecular | transition |
| | Molar ratio of monomer | | | weight | temperature |
| | AA | AN | AMPS | (g/mol) | (° C.) |
| Preparation | 39 | 59 | 2 | 310,000 | 280 |
| Example 1 | | | | | |
| Preparation | 42 | 58 | 0 | 320,000 | 278 |
| Example 2 | | | | | |
| Preparation | 74 | 0 | 26 | 293,000 | 305 |
| Example 3 | | | | | |
| Preparation | 0 | 74 | 26 | — | — |
| Example 4 | | | | | |

### Example 1

A dispersion was prepared by mixing the acryl-based binder (10 wt % in distilled water) prepared in Preparation Example 1 and boehmite (particle diameter D100: 0.5 μm, particle diameter D50: 0.2 μm, plate-shaped) as a filler at a mass ratio of acryl-based binder:filler=1 part by weight:30 parts by weight based on solid content, adding the mixture to a water solvent, and then milling and dispersing the mixture at 25° C. for 30 minutes using a bead mill.

A composition for forming a heat-resistant layer was prepared by adding trimethylolpropane tris (2-methyl-1-aziridine propionate (tri-functional aziridine-based cross-linking agent) as an aziridine-based cross-linking agent in an amount of 0.1 part by weight (content of 10 wt % of the acryl-based binder) based on solid content to the dispersion and adding water so that the total solid content became 20 wt %.

The composition for forming a heat-resistant layer was respectively coated to a thickness of 1.5 μm on both sides of a polyethylene film (thickness: 8 μm, SK Company, air permeability: 120 sec/100 cc, puncture strength: 480 kgf) as a porous substrate by die coating. A heat-resistant layer was manufactured by drying and aging in an oven at 80° C. for 16 hours.

A separator for a rechargeable lithium battery was manufactured by diluting a cross-linked polymethyl (meth)acrylate polymer (cross-linked PMMA) (SP-187, ZEON) as an adhesive binder to a concentration of 2 wt % solid content, then coating each of both surfaces of the heat-resistant layer with the above polymer to a thickness of 0.5 m at the loading amount of 0.2 g/m² with respect to a negative electrode plate surface, and then drying the polymer at 50° C. for 10 minutes to form an adhesive layer with a total thickness of about 1.0 μm.

### Examples 2 to 7

A separator for a rechargeable lithium battery was manufactured in the same method as in Example 1, with a difference that in Example 1, as illustrated in Table 2 below, boehmite was used as the filler, but the D50 and D100 was changed, the mass ratio of the acryl-based binder and filler was changed, and the content of the aziridine-based cross-linking agent and the content of the adhesive binder were changed.

### Comparative Examples 1 to 7

A separator for a rechargeable lithium battery was manufactured in the same manner as in Example 1, with a difference that in Example 1, as illustrated in Table 2 below, the D50 and D100 of the filler, the type of the cross-linking agent, the content of the cross-linking agent, the mass ratio of the (meth)acryl-based binder and filler, the type and/or content of the cross-linking agent, the content of the adhesive binder, etc. were changed.

PVA is a homopolymer of polyvinyl alcohol. An epoxy-based cross-linking agent is ethylene glycol diglycidyl ether.

### Dry Shrinkage Ratio (Units: %)

Samples were manufactured by cutting the separators for a rechargeable lithium battery of Examples and Comparative Examples to a size of 8 cm×8 cm. A shrinkage ratio in each of a mechanical direction (MD) and a transverse direction (TD) was calculated by drawing a square with a size of 5 cm×5 cm on surfaces on the samples, then putting the samples between pieces of paper or alumina powder, leaving the samples in an oven at 150° C. for 1 hour, taking the samples out, and then measuring the side dimensions of the drawn square. The shrinkage ratio was calculated according to Equation 1 below.

$$Shrinkage ratio = ( L 0 - L 1 ) / L 0 \times 100 \qquad Equation l$$

L0 denotes an initial length of the separator, and L1 denotes a length of the separator after being left at 150° C. for 1 hour.

Shrinkage ratio in electrolyte (units: %) Samples were manufactured by cutting the separators for a rechargeable lithium battery of Examples and Comparative Examples to a size of 5 cm×5 cm.

A positive electrode slurry was prepared by mixing 97 wt % LiCoNiAl as a positive electrode active material and 1.5 wt % carbon nanotubes and 1.5 wt % polyvinyl fluoride as a conductive material and adding water thereto. A positive electrode was manufactured by applying the prepared positive electrode slurry to aluminum foil and drying and rolling the prepared positive electrode slurry.

A negative electrode active material slurry was prepared by mixing 97.4 wt % a negative electrode active material, 1.0 wt % carboxymethyl cellulose, 1.5 wt % styrene-butadiene-based rubber, and 0.1 wt % carbon nanotubes as a conductive agent. Artificial graphite was used as the negative electrode active material. A negative electrode was manufactured by applying the prepared negative electrode slurry to aluminum foil and drying and rolling the prepared negative electrode slurry.

One sample was located between the positive electrode and the negative electrode to form three sets of positive electrode-sample-negative electrode laminates, which were then put in a pouch. 3 g of an electrolyte (ethylene carbonate, ethyl methyl carbonate, and dimethyl carbonate (a volume ratio of 30:50:20) in which 1.5M LiPF₆ was dissolved) was injected to completely saturate the laminate with the electrolyte, which was sealed and left at 25° C. for 12 hours. Then, a shrinkage ratio was calculated by leaving the laminate in the oven at 150° C. for 1 hour, then taking the sample out and cooling the sample, and then measuring the side dimensions of the sample.

### Presence or Absence of Cross-Linking

Samples were manufactured by cutting the separators for a rechargeable lithium battery of Examples and Comparative Examples to a size of 5 cm×5 cm. When the sample was fully immersed in deionized water at 25° C. and left for 25 hours, whether the filler was detached from the coating layer was visually checked. When the filler is not detached, it indicates that the coating layer composition is cross-linked, and when the filler is detached, it indicates that the coating layer composition is not cross-linked.

### Wet Bonding Strength (Units: Gf/Mm)

Samples were manufactured by cutting the separators for a rechargeable lithium battery of Examples and Comparative Examples to a size of 3 cm×8 cm.

A positive electrode slurry was prepared by mixing 97 wt % LiCoNiAl as a positive electrode active material and 1.5 wt % carbon nanotubes and 1.5 wt % polyvinyl fluoride as a conductive material and adding water thereto. A positive electrode was manufactured by applying the prepared positive electrode slurry to aluminum foil and drying and rolling the prepared positive electrode slurry.

A negative electrode active material slurry was prepared by mixing 97.4 wt % a negative electrode active material, 1.0 wt % carboxymethyl cellulose, 1.5 wt % styrene-butadiene-based rubber, and 0.1 wt % carbon nanotubes as a conductive agent. Artificial graphite was used as the negative electrode active material. A negative electrode was manufactured by applying the prepared negative electrode slurry to aluminum foil and drying and rolling the prepared negative electrode slurry.

One sample was located between the positive electrode and the negative electrode, and a positive electrode-sample-negative electrode laminate was put in a pouch. 2.5 g of an electrolyte (ethylene carbonate, ethyl methyl carbonate, and dimethyl carbonate (a volume ratio of 30:50:20) in which 1.5M LiPF₆ was dissolved) was injected, sealed, and then left at 25° C. for 12 hours. Then, the laminate was left to stand for 2 hours in an environment with a pressure of 200 kgf in a 50° C. chamber. In the above sample, the separator is separated from a negative electrode plate by about 10 mm to 20 mm, then the separator is fixed to an upper grip and the negative electrode plate is fixed to a lower grip so that a gap between the grips is 20 mm, and then peeled by being pulled in a 180° direction. After the peeling is started at a peeling speed of 20 mm/min, an average value was obtained by measuring a force required to peel 40 mm three times. The average value is calculated as the average value of the measured values.

### Lifetime Characteristics of Battery

A slurry was prepared by adding LiCoO₂, polyvinylidene fluoride, and carbon black to an N-methylpyrrolidone solvent at a weight ratio of 96:2:2. A positive electrode was manufactured by applying the slurry to an aluminum thin film and drying and rolling the slurry.

A slurry was prepared by adding graphite, polyvinylidene fluoride, and carbon black to N-methylpyrrolidone solvent at a weight ratio of 98:1:1. A negative electrode was manufactured by applying the slurry to a copper foil and drying and rolling the slurry.

Jelly roll electrode assemblies in the form of winding were each manufactured by interposing the separators manufactured in Examples and Comparative Examples between the manufactured positive and negative electrodes. Rechargeable lithium batteries were each manufactured by injecting an electrolyte containing 1.15M LiPF₆ added to a solvent in which ethylene carbonate, ethylmethyl carbonate, and diethyl carbonate were mixed at a volume ratio of 3:5:2 into each of the manufactured electrode assemblies and sealing the manufactured electrode assemblies.

For the manufactured battery, a temperature change (ΔT, units: ° C.) and capacity efficiency (units: %) of the separator were evaluated after 10 cycles at 55° C. Charging and discharging conditions are as follows:
Charging: CC1.0 C to 4.4 V, CV to 0.01 C
Discharging: CC1.0 C to 2.75 V

TABLE 2

| | | | | | | Content | | |
|---|---|---|---|---|---|---|---|---|
| | | | | | | of | | |
| | | | | | | cross- | | |
| | | | | | Cross- | linking | Adhesive binder | |
| | Filler | | | | linking | agent | | Loading |
| | D50 | D100 | Binder:filler | Binder | agent | (wt %) | Type | amount |
| Example 1 | 0.2 | 0.5 | 1:30 | Preparation | Aziridine- | 10 | Cross- | 0.2 |
| | | | | Example 1 | based | | linking | |
| | | | | | | | PMMA | |
| Example 2 | 0.2 | 0.5 | 1:25 | Preparation | Aziridine- | 10 | Cross- | 0.1 |
| | | | | Example 1 | based | | linking | |
| | | | | | | | PMMA | |
| Example 3 | 0.2 | 0.5 | 1:20 | Preparation | Aziridine- | 10 | Cross- | 0.05 |
| | | | | Example 1 | based | | linking | |
| | | | | | | | PMMA | |
| Example 4 | 0.2 | 0.5 | 1:25 | Preparation | Aziridine- | 20 | Cross- | 0.2 |
| | | | | Example 1 | based | | linking | |
| | | | | | | | PMMA | |
| Example 5 | 0.2 | 0.5 | 1:25 | Preparation | Aziridine- | 30 | Cross- | 0.2 |
| | | | | Example 1 | based | | linking | |
| | | | | | | | PMMA | |
| Example 6 | 0.2 | 0.5 | 1:25 | Preparation | Aziridine- | 40 | Cross- | 0.2 |
| | | | | Example 1 | based | | linking | |
| | | | | | | | PMMA | |
| Example 7 | 0.3 | 1.0 | 1:30 | Preparation | Aziridine- | 10 | Cross- | 0.2 |
| | | | | Example 1 | based | | linking | |
| | | | | | | | PMMA | |
| Comparative | 0.2 | 0.5 | 1:20 | Preparation | — | — | Cross- | 0.2 |
| Example 1 | | | | Example 1 | | | linking | |
| | | | | | | | PMMA | |
| Comparative | 0.2 | 0.5 | 1:25 | Preparation | Aziridine- | 10 | — | — |
| Example 2 | | | | Example 1 | based | | | |
| Comparative | 0.6 | 1.3 | 1:20 | Preparation | Aziridine- | 10 | Cross- | 0.2 |
| Example 3 | | | | Example 1 | based | | linking | |
| | | | | | | | PMMA | |
| Comparative | 0.2 | 0.5 | 1:20 | PVA | Aziridine- | 10 | Cross- | 0.2 |
| Example 4 | | | | | based | | linking | |
| | | | | | | | PMMA | |
| Comparative | 0.2 | 0.5 | 1:30 | Preparation | Aziridine- | 10 | Cross- | 0.2 |
| Example 5 | | | | Example 2 | based | | linking | |
| | | | | | | | PMMA | |
| Comparative | 0.2 | 0.5 | 1:30 | Preparation | Aziridine- | 10 | Cross- | 0.2 |
| Example 6 | | | | Example 3 | based | | linking | |
| | | | | | | | PMMA | |
| Comparative | 0.2 | 0.5 | 1:30 | Preparation | Epoxy- | 10 | Cross- | 0.2 |
| Example 7 | | | | Example 1 | based | | linking | |
| | | | | | | | PMMA | |

| | | Dry | | Shrinkage | | | | |
|---|---|---|---|---|---|---|---|---|
| | Presence or | shrinkage | | ratio in | | Wet | Lifetime | |
| | absence of | rate | | electrolyte | | bonding | characteristics | |
| | cross-linking | MD | TD | MD | TD | strength | ΔT | Efficiency |
| Example 1 | Cross-linked | 2.5 | 2 | 3 | 2.5 | 0.18 | 2.1 | 98 |
| Example 2 | Cross-linked | 2.5 | 2 | 3 | 3 | 0.14 | 2.4 | 97 |
| Example 3 | Cross-linked | 2.5 | 2 | 3.5 | 3.5 | 0.10 | 2.3 | 97 |
| Example 4 | Cross-linked | 2.5 | 2 | 10 | 12 | 0.18 | 3.7 | 95 |
| Example 5 | Cross-linked | 2.5 | 2 | 7 | 8 | 0.18 | 4.2 | 96 |
| Example 6 | Cross-linked | 2.5 | 2 | 6 | 9 | 0.21 | 4.9 | 96 |
| Example 7 | Cross-linked | 2.5 | 2 | 7 | 9 | 0.12 | 3.2 | 97 |
| Comparative | Not cross- | 2.5 | 2 | 40 | 45 | 0.17 | 2.5 | 96 |
| Example 1 | linked | | | | | | | |
| Comparative | Cross-linked | 2.5 | 2 | 3 | 3 | 0 | 10 | 97 |
| Example 2 | | | | | | | | |
| Comparative | Cross-linked | 3.5 | 3.5 | 25 | 27 | 0.14 | 3.4 | 96 |
| Example 3 | | | | | | | | |
| Comparative | Not cross- | 40 | 43 | 47 | 45 | 0.03 | 5.3 | 90 |
| Example 4 | linked | | | | | | | |
| Comparative | Cross-linked | 2.7 | 2.5 | 30 | 32 | 0.10 | 5.4 | 90 |
| Example 5 | | | | | | | | |
| Comparative | Cross-linked | 3.4 | 3.2 | 30 | 33 | 0.10 | 4.7 | 91 |
| Example 6 | | | | | | | | |
| Comparative | Cross-linked | 4 | 4 | 37 | 36 | 0.11 | 5.2 | 92 |
| Example 7 | | | | | | | | |

As illustrated in Table 2, the separators for a rechargeable lithium battery according to the Examples exhibit a significantly low dry shrinkage ratio and shrinkage ratio in the electrolyte. Therefore, although not illustrated in Table 2, the separators of the Examples are expected to increase the stability and lifetime of the battery. In addition, the separators of the Examples have high wet bonding strength and improved high-temperature lifetime characteristics.

In contrast, the separators of the Comparative Examples exhibited a higher dry shrinkage ratio and/or shrinkage ratio in the electrolyte than those of the Examples. In addition, although not illustrated in Table 2, the cross-linking reaction did not proceed with the binder prepared in Preparation Example 4.

A separator for a rechargeable lithium battery according to one example embodiment can exhibit a significantly low dry shrinkage ratio and shrinkage ratio in an electrolyte, thereby increasing the stability and lifetime of the battery, reducing a wet shrinkage rate, and improving the high-temperature lifetime characteristics of the battery.

Although example embodiments of the present disclosure have been described above, the present disclosure is not limited thereto and may be modified in any form within the scope of the claims, the detailed description of the present disclosure, and the accompanying drawings, and the modifications also fall within the scope of the present disclosure.

What is claimed is:

1. A separator for a rechargeable lithium battery, the separator comprising:
a porous substrate; and
a coating layer located on at least one surface of the porous substrate,
wherein the coating layer includes a cross-linked product of a binder and a cross-linking agent, a filler, and an adhesive binder,
the binder includes a (meth)acryl-based binder including a structural unit derived from (meth)acrylate or (meth)acrylic acid, a cyano group-containing structural unit, and a sulfonate group-containing structural unit,
the cross-linking agent includes an aziridine-based cross-linking agent,
the filler has a particle diameter D100 of about 1.0 μm or less, and
the adhesive binder includes a cross-linked (meth)acryl-based adhesive binder.

2. The separator of claim 1, wherein the coating layer comprises a composition including the (meth)acryl-based binder, the aziridine-based cross-linking agent, the filler having a particle diameter D100 of about 1.0 μm or less, and the adhesive binder.

3. The separator of claim 1, wherein the coating layer comprises a heat-resistant layer comprising a composition containing the (meth)acryl-based binder, the aziridine-based cross-linking agent, and the filler having a particle diameter D100 of about 1.0 m or less, and an adhesive layer located on the heat-resistant layer and including the adhesive binder.

4. The separator of claim 1, wherein the aziridine-based cross-linking agent comprises one or more of N,N′-toluene-2,4-bis(1-aziridinecarboxamide), N,N′-(methylenedi-p-phenylene)bis(aziridine-1-carboxamide), triethylenemelamine, 1,1-isophthaloyl bis(2-methylaziridine), tris(1-aziridinyl)phosphine oxide, N,N-hexamethylene-bis(aziridine carboxamide), trimethylolpropane tris(2-methyl-1-aziridine propionate), trimethylolpropane tris(beta-N-aziridinyl)propionate, and pentaerythritol tris(3-(1-aziridinyl)propionate).

5. The separator of claim 1, wherein the aziridine-based cross-linking agent is included in an amount ranging from about 5 wt % to about 50 wt % with respect to a content of the (meth)acryl-based binder.

6. The separator of claim 1, wherein a mass ratio of the (meth)acryl-based binder to the filler ranges from about 1:10 to about 1:50.

7. The separator of claim 1, wherein the filler has a particle diameter D50 of about 0.4 μm or less.

8. The separator of claim 1, wherein the filler comprises a plate-shaped inorganic filler.

9. The separator of claim 1, wherein the structural unit derived from (meth)acrylate or (meth)acrylic acid is represented by at least one of Chemical Formula 1, 2, or 3: 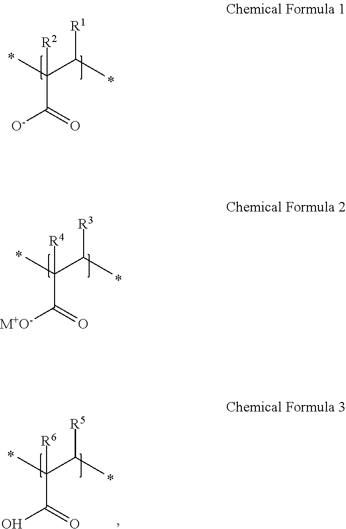
in Chemical Formulas 1 to 3,
R¹, R², R³, R⁴, R⁵, and R⁶ each independently comprises hydrogen or a methyl group, and
in Chemical Formula 2,
M comprises an alkali metal,
the cyano group-containing structural unit is represented by Chemical Formula 4: 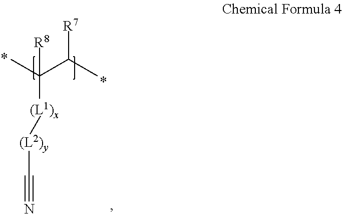
in Chemical Formula 4,
R⁷ and R⁸ each independently comprises hydrogen or a C1 to C3 alkyl group,
L¹ comprises —C(═O)—, —C(═O)O—, —OC(═O)—, —O—, or —C(═O)NH—,
x is an integer ranging from 0 to 2,
L² comprises a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group, and
y is an integer ranging from 0 to 2,
the sulfonate group-containing structural unit is represented by at least one of Chemical Formula 5, 6, and 7: 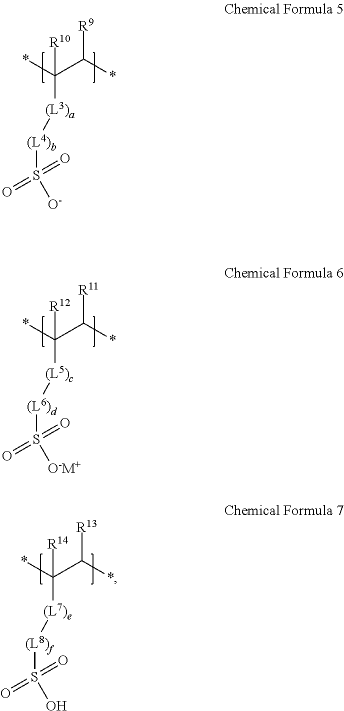
in Chemical Formulas 5 to 7,
R⁹, R¹⁰, R¹¹, R¹², R¹³, and R¹⁴ each independently comprises hydrogen or a C1 to C3 alkyl group,
L³, L⁵, and L⁷ each independently comprises —C(═O)—, —C(═O)O—, —OC(═O)—, —O—, or —C(═O)NH—,
L⁴, L⁶, and L⁸ each independently comprises a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group, and
a, b, c, d, e, and f are each independently an integer ranging from 0 to 2, and
in Chemical Formula 6,
M comprises an alkali metal.

10. The separator of claim 1, wherein the cross-linked (meth)acryl-based adhesive binder comprises cross-linked poly(methyl methacrylate).

11. The separator of claim 1, wherein the coating layer has a thickness ranging from about 1 μm to about 3 μm.

12. A rechargeable lithium battery comprising:
the separator for a rechargeable lithium battery of claim 1;
a positive electrode; and
a negative electrode.
